(19) United States
(12) Patent Application Publication
(10) Pub. No.: US 2026/0348306 A1
(43) Pub. Date: Nov. 5, 2026

(54) TURBOJET ENGINE REAR BODY COMPRISING A STATIONARY SHROUD AND A ROTATABLY MOVABLE SHROUD THAT ARE PROVIDED WITH WINDOWS FOR ADJUSTING A FLUID FLOW RATE

(71) Applicant: SAFRAN AIRCRAFT ENGINES, PARIS (FR)

(72) Inventors: Antoine Baptiste Germain LAFITTE, MOISSY-CRAMAYEL (FR); Antoine LATRILLE, MOISSY-CRAMAYEL (FR); Fanny DEBIEF, MOISSY-CRAMAYEL (FR)

(21) Appl. No.: 19/487,808

(22) PCT Filed: Jun. 19, 2024
(86) PCT No.: PCT/FR2024/050803

§ 371 Date: Nov. 25, 2025

(30) Foreign Application Priority Data
Jun. 23, 2023 (FR) FR2306528

(51) Int. Cl. F01D 25/30

(52) U.S. Cl. CPC F01D 25/30

(57) ABSTRACT

A turbojet engine rear body comprises an exhaust casing carrying a confluence plate that surrounds a primary flow and is surrounded by a secondary flow; an afterburner chamber comprising a casing and a liner defining, together with this casing, an annular space extending along an axis, this liner having a diameter greater than that of the confluence plate; a stationary shroud extending from the confluence plate to the inner liner, this stationary shroud comprising windows; and a movable shroud extending along the stationary shroud and comprising windows, this shroud being rotatably movable about the axis between an open position in which the windows in the stationary shroud are open and a closed position in which the windows in the stationary shroud are closed by the movable shroud.

### TECHNICAL FIELD

The invention applies to the field of military aeronautical propulsion, and more particularly to double-flow turbojet engines equipped with an afterburner chamber.

### PRIOR ART

In a turbojet engine, air enters an inlet duct to pass through a low-pressure compressor before splitting into a central primary flow and a secondary flow surrounding the primary flow.

The primary flow is subsequently compressed in a high-pressure compressor before reaching an afterburner chamber, after which it is expanded in a high-pressure turbine then in a low-pressure turbine before being discharged to the rear. The secondary flow, for its part, is pushed backwards without being compressed.

The primary and secondary flows subsequently pass through an exhaust case located downstream of the low-pressure turbine, which is extended by a confluence plate extending downstream thereof.

In the case of an afterburner turbojet engine, an afterburner nozzle located downstream of the exhaust case collects the primary and secondary flows to inject fuel into it and generate additional afterburner making it possible to temporarily increase the total thrust.

In this afterburner chamber, the fuel is injected by injectors, downstream of which radially extending flame arrestor arms and spark plugs are provided to ignite the injected fuel.

Such an engine can thus operate in a so-called dry speed wherein the afterburner is not activated, or in afterburner speed wherein the afterburner chamber is supplied with fuel.

In such an engine, the dilution rate, which corresponds to the ratio of the secondary flow rate to the primary flow rate, conditions in particular the fuel consumption and the thrust generated. The engine may be designed to match an optimal dilution rate for a given speed, but then it is not optimal at the other speeds.

The engine may also be designed to match an acceptable dilution rate compromise for a given speed range, which is also not completely satisfactory. In any case, this issue is all the more critical as the engine must be able to operate in a wide range of operating speeds (which are generally referred to as “flight domains”).

In this context, the object of the invention is to provide a solution for dynamically adjusting the dilution rate according to the operating speed of the engine.

### DISCLOSURE OF THE INVENTION

To this end, the object of the invention is a turbojet engine including:
an exhaust case carrying a confluence plate in the form of a revolution wall that surrounds a primary flow passing through the turbojet engine, and which is surrounded by a secondary flow passing through the turbojet engine;
an afterburner chamber including a rear casing and an inner liner delimiting with this casing an annular space extending along a longitudinal axis of the engine, this inner liner having a diameter greater than that of the confluence plate;
a stationary shroud extending from the confluence plate to the inner liner, this stationary shroud comprising fluid passage windows;
a movable shroud covering the stationary shroud and which comprises fluid passage windows, this movable shroud being rotatably movable about the longitudinal axis between an opening position wherein the windows of the movable shroud coincide with the windows of the stationary shroud, and a closing position wherein the windows of the movable shroud are offset to close the windows of the fixed shroud.

Adjusting the angular position of the movable shroud about the longitudinal axis makes it possible to modify the flow rate of secondary flow entering the afterburner chamber, which makes it possible to modify the dilution rate of the engine and to adapt it to the operating speed thereof so that this rate is optimal at all engine speeds.

The invention also relates to a rear body thus defined, wherein the movable shroud surrounds the stationary shroud.

The invention also relates to a rear body thus defined, wherein the movable shroud has a shape identical to the shape of the stationary shroud.

The invention also relates to a rear body thus defined, wherein the movable shroud extends around the confluence plate and around the liner.

The invention also relates to a rear body thus defined, wherein the stationary shroud and/or the movable shroud comprises a conical portion wherein the fluid passage windows are formed.

The invention also relates to a rear body thus defined, wherein the windows have crown portion shapes the long sides of which extend circumferentially about the longitudinal axis.

The invention also relates to a rear body thus defined, wherein these windows are circumferentially spaced apart from one another by a value corresponding to the circumferential length thereof.

The invention also relates to a rear body thus defined, comprising actuation means for moving the rotatably movable liner while the engine is in service.

The invention also relates to a turbojet engine comprising a rear body thus defined.

### BRIEF DESCRIPTION OF THE DRAWINGS

FIG. 1 is a longitudinal sectional general view of an afterburner turbojet engine;

FIG. 2 is a longitudinal sectional view schematically showing an afterburner chamber portion according to the invention;

FIG. 3 is a longitudinal sectional local view showing the shrouds surrounding the confluence plate and the liner;

FIG. 4 is a partial front view of the shrouds when the movable shroud is in the opening position;

FIG. 5 is a partial front view of the shrouds when the movable shroud is in the closed position;

FIG. 6 is a partial front view of the shrouds when the movable shroud occupies an intermediate position;

FIG. 7 is a partial front view of a movable shroud comprising round windows;

FIG. 8 is a partial front view of a movable shroud comprising oblong windows;

FIG. 9 is a partial front view of a movable shroud comprising square windows.

### DETAILED DISCLOSURE OF SPECIFIC EMBODIMENTS

In FIG. 1, the turbojet engine 1 according to the invention has a general shape of revolution extending about a longitudinal axis AX, it comprises at the upstream AM thereof an inlet duct through which air is admitted to pass through a low-pressure compressor 2 before being split into a central primary flow F1 and a secondary flow F2 surrounding the primary flow.

The primary flow F1 is subsequently compressed in a high-pressure compressor 3 before reaching an afterburner chamber 4, after which it is expanded through a high-pressure turbine 6 and a low-pressure turbine 7.

The secondary flow for its part is propelled directly backwards by the low-pressure compressor 2 into a duct delimited externally by a principle casing 8.

The primary flow F1 and secondary flow F2 subsequently pass through an exhaust case 9 located downstream of the low-pressure turbine, which is extended by a confluence plate 11 extending downstream thereof.

This turbojet engine is equipped downstream of the turbine 7 with an afterburner chamber 12 delimited by a rear casing 13, wherein the secondary flow F2 joins the primary flow F1 to form the propulsion flow Fp. The two flows join downstream of the confluence plate 11 which extends the separation between the primary flow F1 and the secondary flow F2.

After passing through the low-pressure turbine 7, the primary flow F1 thus flows between the confluence plate 11 and an outlet cone 14 surrounded by this plate 11 to reach the afterburner chamber 12.

The wall of the rear casing 13 is lined at the chamber 12 by an inner liner 16 delimiting therewith an annular space 17. Part of the secondary flow is directed into this annular space 17 to ventilate it in order to limit heating of the casing 13.

The afterburner chamber corresponds to the rear body of the turbojet engine which may also comprise a nozzle including a convergent portion and a divergent portion which then extend in the extension of the afterburner chamber.

Injectors not shown located downstream of the low-pressure turbine 7 are provided to inject additional fuel in order to generate additional combustion in the chamber 12 when the engine is in afterburner mode. In addition, flame arrestor arms 18 located downstream of the confluence plate 11 ignite the fuel injected by the injectors, when the engine operates in afterburner speed.

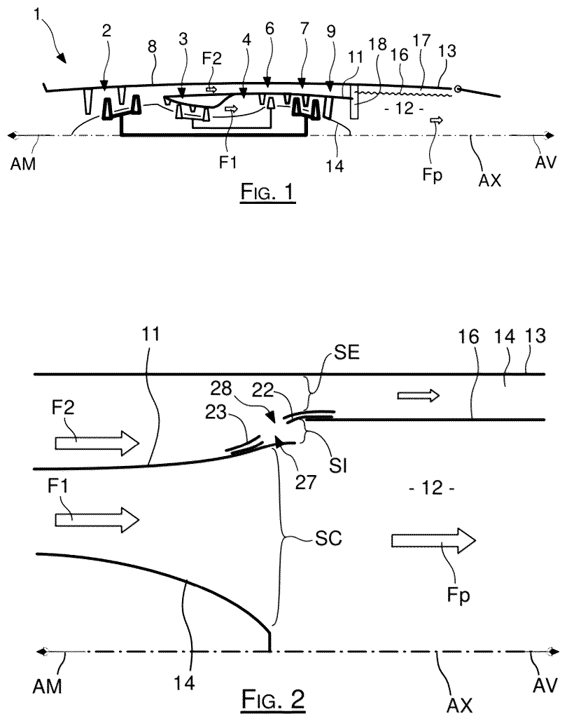

As can be seen in FIG. 2, the liner 16 comprises a circular upstream edge 19 having a diameter greater than the circular downstream edge 21 of the confluence plate 11. The passage section of the flows F1 and F2 to the afterburner chamber 12 is thus divided into an outer section SE corresponding to a crown delimited by the annular space 17, an intermediate section SI corresponding to a crown extending between the plate 11 and the liner 16, and a central section SC delimited internally by the cone 14 and externally by the plate 11.

According to the invention, the engine comprises two shrouds 22 and 23 masking the intermediate section SI by being provided with fluid passage windows, so as to modulate the flow rate passing through this intermediate section. These two shrouds, which are concentric, surround the confluence plate 11 at the upstream ends thereof and they surround the liner 16 at the downstream ends thereof.

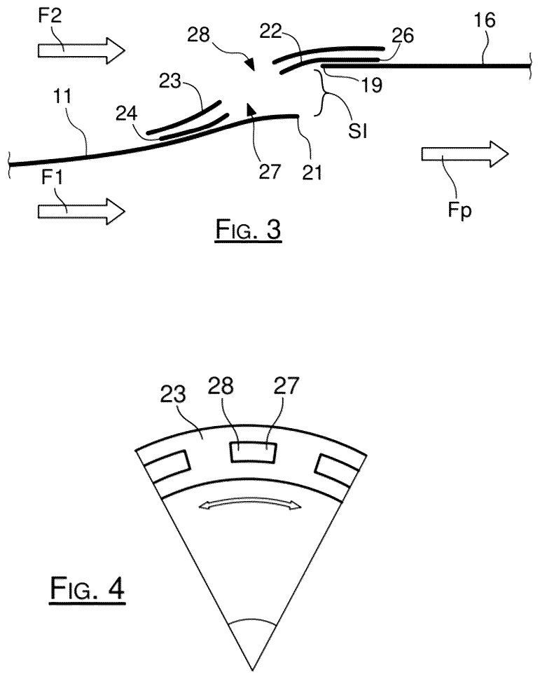

As can be seen in more detail in FIG. 3, the shroud 22, which is stationary, comprises an upstream edge 24 at which it surrounds the outer face of the confluence plate 11, and it flares downstream to a downstream edge 26 at which it surrounds the outer face of the liner 16. This stationary shroud 22 which is for example rigidly secured to the plate 11 and to the liner 16 that it surrounds, comprises windows 27 making it possible for the secondary flow F2 to pass through the intermediate section SI to the inner space delimited by the liner 16.

These windows 27 are formed in the flare portion of the shroud 22, which is a substantially conical portion in the example of the figures, this shroud 22 being for its part a sheet metal revolutionary element.

The movable shroud 23 has a general shape identical to or similar to that of the stationary shroud 22, having substantially larger dimensions, and it surrounds the stationary shroud 22 to be radially superimposed thereon. It also comprises windows, marked with 28, also extending in the flared part thereof, which is here substantially conical.

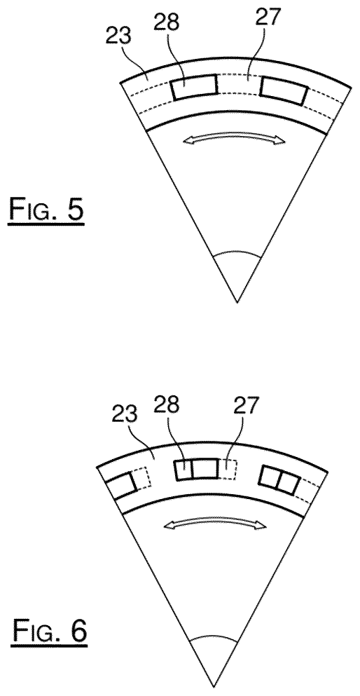

The movable shroud 23 can be rotatably moved about the axis AX, between an opening position and a closing position. In the opening position that corresponds to the situation of FIG. 4, the movable windows 28 coincide with the fixed windows 27 of the stationary shroud 22, so that the flow rate through the intermediate section SI is maximum. In the closed position, as in FIG. 5, the movable windows 28 are circumferentially offset with respect to the stationary windows 27 of the shroud 22 so that the movable shroud 23 completely closes these stationary windows 27, so that the flow rate through the intermediate section SI is substantially zero.

The movable shroud 23 can also occupy any intermediate position, such as for example in FIG. 6, wherein the movable windows 28 are partially offset with respect to the stationary windows 27, so that the flow rate passing through the intermediate section SI is in the order of half of the maximum possible flow rate.

In the example of FIGS. 4 to 6, the windows 27 have crown portion shapes, resembling rectangles, the long sides of which extend in the circumferential direction.

These windows are circumferentially spaced apart from one another by a value corresponding to the length thereof in the circumferential direction in the example of FIG. 2 to. Thus, when the movable shroud is in the maximum opening position thereof, the passage cross-section corresponds to half of the passage cross-section extending between the confluence plate 11 and the liner 16.

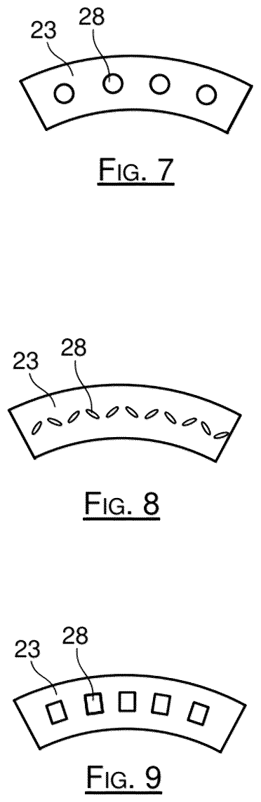

Other window shapes may be envisaged, the windows being round as shown in FIG. 7, they may be oblong having oblique orientations with respect to the radial direction as in the example of FIG. 8, or square as shown in FIG. 9.

The movable shroud 23 can occupy any position between the maximum open position thereof and the complete closed position thereof, so as to modulate the secondary flow rate admitted into the afterburner chamber according to the speed of the engine.

Advantageously, this movable shroud 23 is moved by a control system of the same type as those used for adjusting the angular position of an arrangement of fixed vanes with variable pitch. In this case, an actuator implanted at the outer face of the casing comprises an actuating member connected to the movable shroud, so as to be able to place it in any angular position between the maximum opening position and the maximum closing position.

Such an actuator may be a motor equipped with a pinion engaged in an outer toothing of the movable shroud, or a cylinder having a movable rod by which it is connected to the outer shroud.

This actuator is then controlled by a turbojet engine control system to adjust the angular position of the movable shroud about the AX axis, in real time according to the operating speed of the engine.

What is claimed is:

1. A turbojet engine rear body including:
an exhaust case carrying a confluence plate in the form of a revolution wall that surrounds a primary flow passing through the turbojet engine, and that is surrounded by a secondary flow passing through the turbojet engine;
an afterburner chamber including a rear casing and an inner liner delimiting with this casing an annular space extending along a longitudinal axis of the engine, this inner liner having a diameter greater than that of the confluence plate
a stationary shroud extending from the confluence plate to the inner liner this stationary shroud comprising fluid passage windows; and
a movable shroud covering the stationary shroud and which comprises fluid passage windows, this movable shroud being rotatably movable about the longitudinal axis between an opening position wherein the windows of the movable shroud coincide with the windows of the stationary shroud, and a closing position wherein the windows of the movable shroud are offset to close the windows of the stationary shroud.

2. The turbojet engine rear body according to claim 1, wherein the movable shroud surrounds the stationary shroud.

3. The turbojet engine rear body according to claim 1, wherein the movable shroud has a shape identical to the shape of the stationary shroud.

4. The turbojet engine rear body according to claim 1, wherein the movable shroud extends around the confluence plate and around the liner.

5. The turbojet engine rear body according to claim 1, wherein the stationary shroud and/or the movable shroud comprises a conical portion wherein the fluid passage windows are formed.

6. The turbojet engine rear body according to claim 1, wherein the windows have crown portion shapes the long sides of which extend circumferentially about the longitudinal axis.

7. The turbojet engine rear body according to claim 1, wherein these windows are circumferentially spaced apart from one another by a value corresponding to the circumferential length thereof.

8. The turbojet engine rear body according to claim 1, comprising actuating means for rotatably moving the movable shroud while the engine is in service.

9. A turbojet engine comprising the turbojet engine rear body according to claim 1.
